(19) United States
(12) Patent Application Publication
(10) Pub. No.: US 2024/0219202 A1
(43) Pub. Date: Jul. 4, 2024

(54) INFORMATION VERIFICATION FOR LOCATION MAPPING

(71) Applicant: RealWork Labs, Inc., Austin, TX (US)

(72) Inventors: Pierce Birkhold, Austin, TX (US); Morten Moeller, Austin, TX (US)

(21) Appl. No.: 18/531,353

(22) Filed: Dec. 6, 2023

Related U.S. Application Data
(60) Provisional application No. 63/436,073, filed on Dec. 29, 2022.

(51) Int. Cl. G01C 21/00

(52) U.S. Cl. CPC G01C 21/3874; G01C 21/3885

(57) ABSTRACT

A method and related system for aggregating verified data with location information include providing, to a client device, a link to an intermediate destination, obtaining a redirection time from the client device via the intermediate destination, and obtaining a location and user identifier. The method also includes retrieving evaluation data comprising a text sequence, an evaluation time, and a candidate user identifier and determining a result indicating that the evaluation data satisfies a set of verification criteria. The method further includes updating a record associated with a geographic region in a map-related data store in response to determining the result. Updating the record includes selecting the record associated with the geographic region based on the location and updating the record associated with the geographic region to comprise the text sequence.

### CROSS-REFERENCE TO RELATED APPLICATIONS

This application claims priority to U.S. Provisional Application No. 63/436,073 (titled “COMBINING CONTENT TO LOCATION FOR INFORMATION VALIDATION AND VERIFICATION” and filed on Dec. 29, 2022), the entirety of which is incorporated by reference herein.

### BACKGROUND

Modern information systems use user-provided information to provide other users with meaningful metrics indicating types, categories, or features. For example, an online application may retrieve user-provided text or images indicating a record in order to generate a set of values to generate characterization values of the record. In many such cases, this user-provided information may be stored in association with a location on a geographic map, where such restrictions to a geographic map may help increase the relevance of future search operations for a user. However, such user-provided information is susceptible to malicious activity, such as the intentional injection of false information or the obfuscation of actual information by providing noise or irrelevant information.

### SUMMARY

Information systems can use user-provided information related to tasks to characterize the task. However, such information can become plagued with misleading noise (e.g., spam), misinformation, or false information. Such issues become especially problematic in the case of physical task evaluation because objective metrics of task quality are difficult for users to accurately assess. Moreover, while visual evidence may be sufficient to indicate that a physical object was delivered or provided, such visual evidence is often insufficient for an evaluation-providing user to indicate the performance or nonperformance of a task. Furthermore, when such physical tasks are restricted to a geographic constraint, geographic restrictions may be artificially applied to a physical address unrelated to the location at which the task was actually performed. For example, a database record may associate a task with a first address of a service provider that performed the task instead of a second address at which the task was performed.

Some embodiments may overcome the technical issues and other technical issues discussed in this disclosure by performing operations to send, to a client device, a link to an intermediate destination that redirects a user to evaluation entry interface. Some embodiments may obtain a redirection timestamp from the client device via the intermediate destination. Some embodiments may obtain a location and a user identifier associated with the client device. Some embodiments may obtain evaluation data from a data store, wherein the evaluation data includes a text sequence representing user-provided text input, an evaluation timestamp, and a candidate user identifier. Some embodiments may determine a result indicating that the evaluation data satisfies a set of verification criteria, wherein satisfying the set of verification criteria includes determining that the evaluation timestamp is within a threshold duration of the redirection timestamp and detecting a match between the candidate user identifier and the user identifier. Some embodiments may, in response to determining the result, update a record associated with a geographic region in a map-related data store. Updating the record may include selecting the record associated with the geographic region based on the location and updating the record associated with the geographic region to include the text sequence.

Various other aspects, features, and advantages will be apparent through the detailed description of this disclosure and the drawings attached hereto. It is also to be understood that both the foregoing general description and the following detailed description are examples and not restrictive of the scope of the invention.

### BRIEF DESCRIPTION OF THE DRAWINGS

FIG. 1 shows an illustrative computer system for anonymizing and associating geographic information with assessments, in accordance with one or more embodiments.

FIG. 2 is a flowchart of a process for associating verified evaluation data with geographic information, in accordance with one or more embodiments.

FIG. 3 shows a flowchart of a process for associating evaluation data with geographic regions, in accordance with one or more embodiments.

FIG. 4 shows a flowchart of a process for anonymizing visual information to maintain user privacy, in accordance with one or more embodiments.

FIG. 5 is an example graphic user interface (GUI) screen that includes a geographic map and geographic locations representing geographic regions, in accordance with one or more embodiments.

FIG. 6 is an example GUI screen used by a first user to provide geographic location information for a service, in accordance with one or more embodiments.

FIG. 7 is an example GUI screen used by a first user to provide task-related information, in accordance with one or more embodiments.

FIG. 8 is a block diagram of a computer system that may be used to implement certain features of some of the embodiments.

The technologies described herein will become more apparent to those skilled in the art by studying the detailed description in conjunction with the drawings. Embodiments of implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

In the following description, for the purposes of explanation, numerous specific details are set forth in order to provide a thorough understanding of the embodiments of the invention. It will be appreciated, however, by those having skill in the art, that the embodiments of the invention may be practiced without these specific details or with an equivalent arrangement. In other cases, well-known structures and devices are shown in block diagram form in order to avoid unnecessarily obscuring the embodiments of the invention.

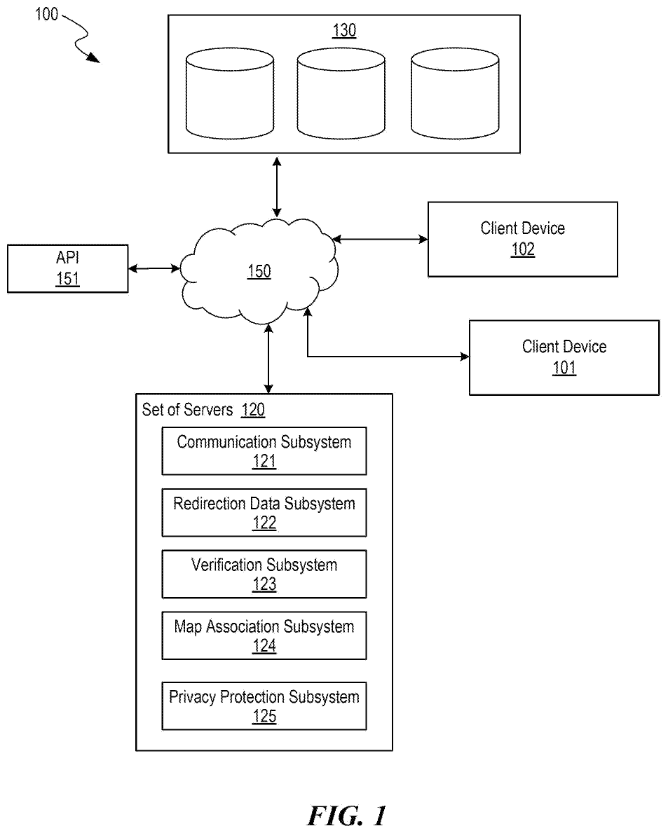

FIG. 1 shows an illustrative computer system for anonymizing and associating geographic information with assessments, in accordance with one or more embodiments. A system 100 includes a first client device 101 and a second client device 102, where either or both devices may perform one or more operations described in this disclosure. The client devices 101-102 may include various types of computing devices, such as a laptop computer, a desktop computer, a wearable headset, a smartwatch, another type of mobile computing device, etc. In some embodiments, either or both of the client devices 101-102 may communicate with various other computing devices via a network 150, where the network 150 may include the Internet, a local area network, a peer-to-peer network, etc.

The client devices 101-102 may send and receive messages through the network 150 to communicate with a set of servers 120, where the set of servers 120 may include a set of non-transitory, computer readable media (e.g., “storage media”) storing program instructions to perform one or more operations of subsystems 121-125. While one or more operations are described herein as being performed by particular components of the system 100, those operations may be performed by other components of the system 100 in some embodiments. For example, one or more operations described in this disclosure as being performed by the set of servers 120 may instead be performed by the first client device 101. Furthermore, some embodiments may communicate with an API of a third-party data service via the network 150 to perform an image recognition operation or use other services that perform one or more operations described in this disclosure.

In some embodiments, the set of computer systems and subsystems illustrated in FIG. 1 may include one or more computing devices having electronic storage or otherwise capable of accessing electronic storage, where the electronic storage may include the set of data stores 130. The set of data stores 130 may include values used to perform operations described in this disclosure, such as data associated with organizations, services, users, geographic locations, geographic sectors, machine learning model parameters, machine learning model outputs, etc. In some embodiments, the set of subsystems 121-125 may perform operations described in this disclosure. Furthermore, as used in this disclosure, a data store may include traditional relational databases, NoSQL databases (e.g., document stores, ke-value stores, wide-column stores, graph databases), object stores, in-memory data stores, flat file data storage, in-memory databases,

In some embodiments, a communication subsystem 121 may send and receive messages with other applications or services executing on other computing devices, such other servers, the set of data stores 130, the first client device 101, etc. For example, the communication subsystem 121 may send map-related data to the first client device 101 or the second client device 102 that includes the evaluation data provided by other users or locations associated with the evaluation data. Alternatively, or additionally, the communication subsystem 121 may obtain data from the first client device 101 or the set of data stores 130. For example, the communication subsystem 121 may send messages to the set of data stores 130 based on operations described in this disclosure, such as indications that an image includes private information, an association between evaluation data and a location, etc.

In some embodiments, a redirection data subsystem 122 may collect information from an intermediate destination that redirects a device to a second network or internet destination. For example, some embodiments may provide a link to the first client device 101. After a user interacts with the first client device 101, the first client device 101 may first visit a redirection page or other intermediate destination via a native web browser operating on the first client device 101. The intermediate destination may automatically capture certain information from the first client device 101, such as a device location, a time value (e.g., a redirection page visit time or other intermediate destination visit time), a device identifier of the first client device 101, a user identifier of a user using the first client device 101, an organization identifier provided in a context of a visit to the intermediate destination, a user category, a task identifier or other indicator of a service type, a computing resource or other resource associated with the task identifier or other indicator of service type, or some other type of information.

The client device 102 may then be redirected to an evaluation interface on a web page or native application operating on the first client device 101 via the redirection page. In some embodiments, the redirection page or other intermediate destination may store a set of data-tracking values in the first client device 101. For example, some embodiments may store a cookie in the web browser of the first client device 101, where the cookie may be used to track a user while or after the first client device 101 is redirected from the intermediate destination to a second destination. Some embodiments may then collect the stored information in the cookie during a later visit to the intermediate device via another application executing on the first client device 101.

A user of the first client device 101 may then provide evaluation data via the evaluation interface, where the evaluation data may include text input, image data such as images and video, audio data, and an organization identifier. Additionally, or alternatively, the evaluation data may be associated with a user identifier, an organization identifier, an evaluation time representing a time of data entry or a service time during which a task identified by a task identifier is performed, etc.

In some embodiments, the set of servers 120 may directly send a redirection link to an intermediate destination to the first client device 101. Alternatively, a native application executing on the first client device 101 may provide the user with a link to an intermediate destination. For example, a user of the second client device 102 may send a request to send a redirection link to the set of servers 120 that causes the set of servers 120 to send the redirection link to the first client device 101. A user of the first client device 101 may then interact with the redirection link and cause a native web browser or other native application executing on the first client device 101 to access an intermediate destination, such as a redirection page. Scripts or other program instructions executing on the intermediate destination may then cause the first client device 101 to access a second destination, such as an evaluation data entry interface.

In some embodiments, a verification subsystem 123 may verify that data obtained from a third-party system satisfies a set of verification criteria based on data obtained via the redirection data subsystem 122. In some embodiments, the communication subsystem 121 may obtain evaluation data from an application program interface (API) 151, where the evaluation data may be provided by the first client device 101. The verification subsystem 123 may retrieve a set of criteria based on information provided by the redirection data subsystem 122. For example, some embodiments may obtain user-provided information.

Some embodiments may use the verification subsystem 123 to verify that data obtained from a third-party data system should be used to update a local record based on a determination that the obtained data satisfies a set of verification criteria. In some embodiments, verifying that a set of data should be used to update a record may include a criterion that a timestamp or other time value provided in the obtained data or otherwise associated with the obtained data satisfies a threshold duration. The threshold duration may be based on a previously obtained time value, such as a user-provided time value or a time value obtained from an intermediate destination. For example, some embodiments may obtain, from a first user operating a first client device, a request to send a link to a second user operating a second device. In some embodiments, the request may be associated with a first time value, where the first time value may be a timestamp indicating the starting time of a task, completion time of the task, time at which the first user started the request, etc. Some embodiments may then obtain data from a third-party database or other data source and determine whether the obtained data satisfies a threshold duration for a duration starting at the first time value and ending at a default interval after the first time value. For example, some embodiments may set the default interval to be a time less than or equal to 1 hour, 2 hours, 6 hours, 12 hours, 1 day, 3 days, 7 days, 30 days, or some other duration.

Alternatively, or additionally, some embodiments may determine the first time value used to determine the threshold duration based on a time value provided by an intermediate destination. For example, after visiting a redirection page, data provided by the redirection page may be used to determine the first time value. Various types of operations may be used to visit the redirection page to obtain a time value. For example, some embodiments may cause the first client device 101 to visit a redirection page by providing the first client device 101 with a hyperlink that includes both the address of the redirection page and additional field values. In some embodiments, the additional field values may include information such as a task identifier, a task completion time, an organization identifier, a location at which a task was completed, an image address (e.g., a hyperlink to a still image or video stored in a data repository), another hyperlink, additional information indicating task type or task status, or other information. Such additional information may be provided by a user of the second client device 102. For example, an operating user of the second client device 102 may send a request to the set of servers 120, where the request includes task-associated values that include a task identifier indicating a task completed by the operating user, a timestamp indicating a time of task completion, a task type associated with the task identifier, one or more metrics characterizing the task, and a geographic location of task completion. After processing the request, the redirection data subsystem 122 may then send a hyperlink that includes both the address to a destination and a character string that encodes or otherwise includes the task-associated values. After receiving the hyperlink at a first client device 101, the user of the first client device 101 may then interact with the hyperlink, or a native application executing on the first client device 101 may automatically access the destination indicated by the hyperlink. In some embodiments, the additional field values encoded in the hyperlink may be collected by the destination from the first client device 101. Some embodiments may then use the redirection page-provided time to determine a threshold duration and determine whether an evaluation time indicating a time of evaluation data submission is within the threshold duration.

Some embodiments may include operations to obtain a set of restricted features indicated to represent identifying information. For example, some embodiments may obtain a video stream or other image data from a user. Some embodiments may then provide the image data to an object recognition model or another type of machine learning model to detect one or more features to associate with the image data, where the feature may include a classification of a portion of an image. As used in this disclosure, an object recognition model includes various machine learning models that are trained to identify one or more objects in image data, where such objects may be described as features of the image data upon identification. For example, some embodiments may provide an image to an object recognition model to detect the presence of the text “CONTENT1” or other image data, where the set of features may include either or both the category “text” and “CONTENT1” as features associated with the portion of the image that includes the text “CONTEXT1.” The object recognition model may include various machine learning models adaptable to computer vision (CV) operations, such as convolutional neural network (CNN). Various types of CNNs may be used, such as a region-based CNN, a recurrent CNN, a single shot multibox detector, a mask-based CNN, or a combination of other machine learning models. Some embodiments may use different models or model configuration parameters based on the data being analyzed. For example, some embodiments may use a region-based CNN or a single shot multibox detector if an input data to an object recognition model is a still image or use a recurrent CNN if the input data to the object recognition model includes video data.

In response to a determination that an object matching the list of identifying objects has been detected in an image, some embodiments may warn a user or modify the image to remove or obfuscate the identifying information. For example, some embodiments may obtain a list of objects that includes the category “dog.” Some embodiments may then perform operations that include first detecting that a dog is in an image, determining that “dog” is part of a list of objects indicating identifying information, and modifying the portion of the image that contains the dog to remove the image.

In some embodiments, a record update subsystem 124 may update a record to include or otherwise associate the record evaluation data, where the record may also be associated with a geographic region, task identifier, or task-performing entity (e.g., a user or an organization). In some embodiments, the record update subsystem 124 may generate or otherwise update a record in a database (e.g., a database of the set of data stores 130) after receiving a message from a task-performing entity indicating the start or completion of a task. In some embodiments, the data in the message (e.g., a task location, a task start time, a task ending time, a task-performing user, a customer or other task-evaluating user, etc.) may be used to populate one or more values of the record. Furthermore, in some embodiments, the record update subsystem 124 may generate or update a set of map-related records in the set of data stores 130. The record update subsystem 124 may generate or update a record to include data from other data sources, such as data acquired from a third-party database that is accessed via an API of the third-party database. The record update subsystem 124 may generate or update a record in response to receiving an indication from the verification subsystem 123 that data provided from a data source satisfies a set of verification criteria indicating that the data is related to a task associated with an organization and a geographic location.

Some embodiments may store a record of evaluation data in a database of evaluations or another type of data store, where the record may include or be associated with other information, such as geographic locations, geographic regions, images, video, physical resources, service providers, etc. For example, based on a determination that a verification score for evaluation data analyzed by the verification subsystem 123 satisfies a verification score threshold, some embodiments may update one or more records of an evaluation data store or other data store based on the evaluation data. Alternatively, if a verification score for a set of evaluation data is less than a verification threshold, some embodiments may prevent the record from being updated based on the set of evaluation data, even if one or more values of the set of evaluation data match with one or more values of the record.

Some embodiments may update records of a map-related data store that comprises records accessible based on geographic locations or geographic regions. In some embodiments, a record may indicate a set of geographic locations or a set of geographic regions for a geographic super-region, such that an update to the record may change a visual depiction of the geographic super-region. Furthermore, some embodiments may index evaluation data based on geographic regions, where a query may cause a database search through a set of records indexed by the geographic regions. For example, some embodiments may receive a query indicating a first geographic location. Some embodiments may then determine a set of geographic regions associated with the first geographic location and retrieve a set of records associated with the geographic regions. As described elsewhere in this disclosure, some embodiments may retrieve the set of records without requiring any specific geolocation of the retrieved set of records.

In some embodiments, a privacy protection subsystem 125 may perform operations to provide users with a means of providing location-specific information in an obfuscated way. Some embodiments may obtain images acquired by a user device and perform one or more anonymization operations on the set of information. Such anonymization may include blurring text that may be considered identifying information, such as street information, names, addresses, etc. For example, some embodiments may include an object detection system to detect whether a person, part of a person, or other type of identifying information is in an image (e.g., a street number sign in an image). Some embodiments may then cause a user interface (UI) to present a warning indicating the detection of the identifying information or perform operations to modify the image to remove or obfuscate the identifying information.

Some embodiments may include options for a user to filter the extent of anonymization operations. For example, some embodiments may perform operations to detect that a human arm is present in an image and then perform operations to determine whether the human arm is permitted for display in the image based on a configuration setting associated with a user record. In response to a determination that the arm is not permitted for display based on the configuration setting, some embodiments may cause the UI to display a warning that the human arm is being displayed in the image. Furthermore, some embodiments may include operations to obtain a list of objects indicated to represent identifying information. In response to a determination that an object matching the list of identifying objects has been detected in an image, some embodiments may warn a user or modify the image to remove or obfuscate the identifying information. For example, some embodiments may obtain a list of objects that includes the category “dog.” Some embodiments may then perform operations that include first detecting that a dog is in an image, determining that “dog” is part of a list of objects indicating identifying information, and modifying a section of the image that contains the dog to remove the image.

Alternatively, or additionally, some embodiments may use a positive filter such that only information that can be positively identified as allowable information is not blurred or otherwise obfuscated. For example, after receiving an image, some embodiments may perform an object recognition operation on the image to identify a set of regions corresponding with recognized features. Some embodiments may then determine which of the recognized features corresponds with a list of permitted features indicated by a positive filter. Some embodiments may then blur portions of the image that do not include the regions corresponding with the recognized features associated with a feature in the list of permitted features.

Alternatively, some embodiments may provide an application to the first client device 101 to perform one or more anonymization operations described above, such as blurring or otherwise obfuscating text or image data, removing text or image data, etc. For example, some embodiments may include an object detection system to detect whether a person, part of a person, or other type of identifying information is in an image (e.g., a street number sign in an image). The application may then present a warning indicating the detection of the identifying information or perform operations to modify the image to remove or obfuscate the identifying information.

Some embodiments may include options for a user to filter the extent of anonymization operations for either server-side or client-side obfuscation operations. For example, some embodiments may perform operations to detect that a human arm is present in an image. Some embodiments may then perform operations to determine whether the human arm is permitted for display in the image based on a configuration setting of a web application executing on a set of servers or a client-side native application of a client device. In response to a determination that the arm shown in a candidate image is permitted for display, some embodiments may store the candidate image without blurring the arm.

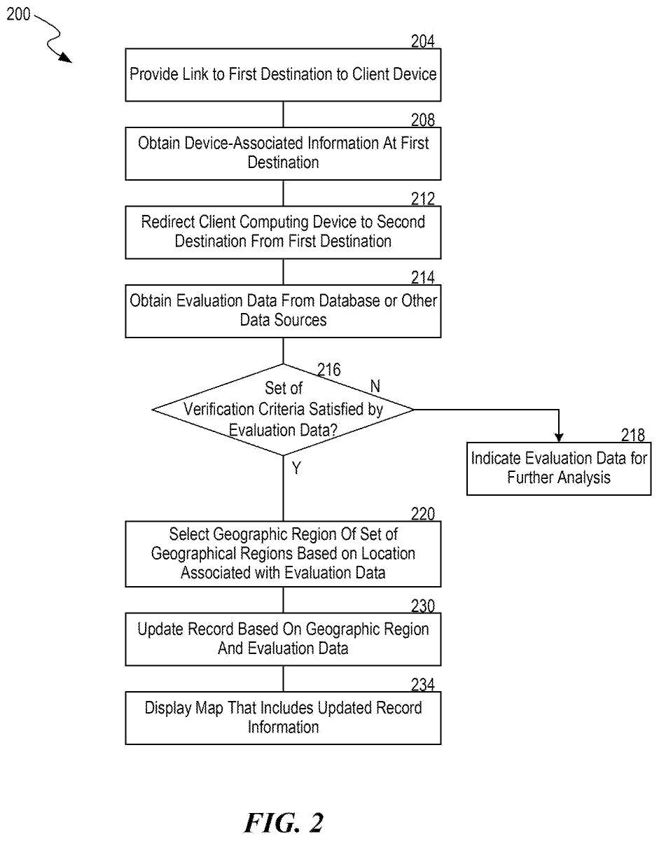

FIG. 2 is a flowchart of a process 200 for associating verified evaluation data with geographic information, in accordance with one or more embodiments. Some embodiments may provide a client device with a link to a first destination, as indicated by block 204. In some embodiments, the link may be a hyperlink or other information related to an address of a redirection page or other intermediate destination. For example, the link may be to a redirection page that, upon being visited by a web browser, will cause the web browser to visit a second web page. Alternatively, or additionally, the redirection page may cause the activation of another application on a computing device that visits the redirection page.

In some embodiments, the link may include or otherwise be associated with additional data. The additional data may include a data store information identifier corresponding with a database record or another set of associated data in a data store, e.g., an identified line in a flat file. For example, the data store information identifier may include a task identifier of a task, a task-related time, a task location, an organization identifier a user identifier. In some embodiments, a database record or other set of data indicated by a data store information identifier may include information indicating an organization or user that performed the task, a condition in which the task was performed, etc. Furthermore, in some embodiments, a client device receiving the link may further augment the link with device-stored data, such as a network performance metric of the client device (e.g., network bandwidth, latency, etc.), a location of the client device, a log of application use of the client device, text stored on the device, or other information stored on the client device.

In some embodiments, the record or other set of associated data in a data store identified by the data store information identifier may include information provided at a previous time. For example, a database record indexed or otherwise identified by a data store information identifier may include data provided by a service provider that indicates information about a client user. For example, as described elsewhere in this disclosure, a service provider user may use a GUI screen to provide task-related information for task that is then stored in a database record. In some embodiments, the task-related information may include a location for the task and a customer name or other user identifier (e.g., a series of computer-generated alphanumeric characters) indicating a customer for whom the task was performed.

In some embodiments, a link to a destination may be a hyperlink that is shortened to a reduced URL. In some embodiments, the link may be sent via Short Message Service (SMS) text messaging, electronic mail, a Quick Response (QR) code, a dedicated messaging platform, etc. For example, some embodiments may receive a phone number in conjunction with a request to send a link to a first computing device and, in response, send an SMS message to the phone number that includes a link to a first destination. Alternatively, or additionally, a service-provider-associated client device may display a QR code on a display screen, where the QR code encodes a link to the first destination. The first client device may scan the QR code and, in response to receiving the QR code, may access the first destination by decoding the encoded link. In some embodiments, the first destination may redirect a visiting web browser to another web page or web application user interface. Alternatively, or additionally, some embodiments may include a default link to a web address that retrieves data stored on a web browser or native application or other information stored on the client device, where the default link may then cause a computer system to perform different operations based on the retrieved data.

Some embodiments may obtain device-provided information at the first destination, as indicated by block 208. With respect to the device-provided information, some embodiments may perform operations to detect whether the client device has sent a request to access the first destination. Some embodiments may then store client-associated information when the client device attempts to access the first destination. For example, some embodiments may store information about a timepoint indicating when the client device accessed the first destination, a geographic location of the client device (e.g., geographic information obtained from an Internet Protocol (IP) address, GPS coordinates, or other geographic information), an IP address, a user identifier, a client device identifier, or other information.

Some embodiments may store information on the client device for identification purposes. For example, some embodiments may store a cookie on the client device to help track the client device or identify the client device as the computing device is used to enter information at another web page or other destination. While some web browsers may prevent the storage of such cookies, other web browsers may permit the storage of such cookies, where some embodiments may use multiple methods to match a client device or geolocation with an assessment, as described elsewhere in this disclosure.

As described elsewhere in this disclosure, some embodiments may provide a link to a client device or otherwise cause a link to appear on a client device that includes a set of additional values. For example, a user of a first device may send a request to a server executing a controlling application, where the request may include a task identifier for a service, location information (e.g., coordinates, a street address, a zip code, a site name), a servicing user identifier or organization identifier associated with an entity completing the task, a receiving user identifier or organization identifier associated with an entity for which the task is being performed, a time value, etc. A task identifier may include a sequence of characters that maps to a record representing a task, a specific task name, a task category, etc. For example, a task identifier may include the value “ROOF1,” where “ROOF1” maps to a task record representing a roofing job. As described elsewhere, the task record may include or be associated with a set of restricted features, include a set of target features, or include other values. In some embodiments, different tasks may be associated with different sets of restricted features, different sets of target features, or different sets of other values.

Some embodiments may then store the set of additional values in association with the request or a number associated with the request. Alternatively, or additionally, some embodiments may generate a data-augmented link that includes both an address to a destination as well as a representation of the set of values. Alternatively, or additionally, some embodiments may send a message to be received by a native application executing on a client device. In response to receiving the message, the native application may then generate a data-augmented link that includes both an address to a destination as well as a representation of the set of values and display the link to a user of the client device. After a user accesses the destination indicated by the data-augmented link, the destination may include one or more scripts, functions, or other executing program code that collects the additional information stored in the data-augmented link. It should be understood that device-associated information may include any additional values communicated via a data-augmented link. In some embodiments, data communicated via the data-augmented link may be used to verify or otherwise validate user-generated evaluation data.

In some embodiments, the first destination may collect user information that is directly retrieved from a user device without first being provided by link. For example, some embodiments may access a device memory to retrieve one or more cookies stored in a web browser memory of the client device. Such memory-stored values may include session information for a server, user identifier information, security token information, third-party tracking information, user preferences, etc. In some embodiments, identity information, location information, temporal information, or other information retrieved from the user device may be used to verify or otherwise validate user-generated evaluation data.

Alternatively, or additionally, some embodiments may information used in operations described in this disclosure by using information encoded or otherwise stored in a link to retrieve previously stored information. For example, some embodiments may have previously provided a link to a client device, where the link includes a data store information identifier. Some embodiments may then generate a query based on the data store information identifier. For example, if the data store information identifier is the numeric value “120652,” some embodiments may obtain location information and a user identifier by generating the SQL query “SELECT clientLoc, clientUserID FROM jobTable WHERE indexColumn=120652,” where “jobTable” is a database used to store records for tasks performed by a service provider user for a client user, “clientLoc” is a location provided by the a service provider user to indicate a location at which the task was performed, and “clientUserID” is an identifier assigned to the client user for whom the task was performed.

Some embodiments may redirect the client device from the first destination to the second destination, as indicated by block 212. In some embodiments, the first destination may be an intermediate destination, where access to the intermediate destination may cause some embodiments to perform operations described by block 208 or elsewhere in this disclosure. The intermediate destination may use one of various mechanisms to redirect a user to a second destination. In some embodiments, the intermediate destination may include JavaScript program instructions that cause a redirection to a second destination. Alternatively, or additionally, the intermediate destination may include HTML code instructions that cause a browser to redirect to a second destination. Alternatively, or additionally, a browser that sends a request to access the intermediate destination may be provided with a response from a server that indicates a redirection (e.g., with a code 301 representing a permanent move, 302 representing a temporary move, or 307 representing a temporary redirect). Furthermore, in some embodiments, an intermediate destination may cause an application to open or execute another application, where a UI display of the other application is the second destination. For example, some embodiments may provide a redirection page that causes a client device to request that a user open a map-related program installed on the client device.

Some embodiments may obtain data from one or more additional data sources, as indicated by block 214. Some embodiments may obtain the data from a data source related to a second destination of an intermediate destination. For example, after the client device is redirected to the second destination, a user may provide evaluation data at the second destination, where such data may include an image, a video, a text sequence related to a task, another type of text input related to a task, or other types of data. In some embodiments, the user-provided evaluation data may be stored in a data store that is directly accessible to one or more applications described in this disclosure.

In some embodiments, user-provided evaluation data may be stored in a third-party data source that may require external permission to access. For example, some embodiments may obtain user-provided evaluation data from a third-party data source by sending a set of requests to an API of the third-party data source, where such requests may be limited based on configuration parameters of the third-party data source. Some embodiments may perform operations to wait a preset amount of time before accessing a third-party data source via an API request to the API of the third-party data source, where the preset amount of time may be determined based on a time that a link was sent or otherwise displayed on a client device. For example, some embodiments may receive a time value indicating that a task was performed at time to and wait a preset duration before providing an API request that includes a user identifier, an organization identifier, a geographic region identifier, or other values used to perform a query for user-provided text inputs or other user-provided data. The preset duration may be a time less than 1 day, a time less than 2 days, a time less than 3 days, a time less than 7 days, or some other amount of time. After receiving the API request, a third-party data store or other type of data source may provide a text sequence representing text content provided by a user, image data, a link representing an image address, or other data.

Some embodiments may determine whether a set of verification criteria is satisfied based on the evaluation data, as indicated by block 216. The set of verification criteria includes one or more criteria indicating that user-provided evaluation data (e.g., user-provided text input) is verifiably associated with a task or a geographic location. In some embodiments, satisfying a set of verification criteria may require that each criterion of the set of verification criteria is satisfied. Alternatively, in some embodiments, satisfying a set of verification criteria may require that a subset of criteria of the set of verification criteria is satisfied. Alternatively, in some embodiments, satisfying a set of verification criteria may require determining a verification score based on evaluation data and determining whether the verification score satisfies a verification score threshold.

In some embodiments, the set of verification criteria may include determining whether an evaluation timestamp is within a duration threshold of a redirection time, where the redirection time may indicate a time during which a user visited or attempted to visit an intermediate destination. For example, a redirection time may include a redirection timestamp “2025-12-13T09:45:30” to represent a time at which a client device visited an intermediate destination or was redirected away from the intermediate destination. In some embodiments, the duration threshold may be equal to or less than 10 minutes, 30 minutes, 1 hour, 3 hours, 6 hours, 12 hours, 24 hours, 3 days, 7 days, or some other pre-configured duration. For example, some embodiments may obtain, from a redirection page, an indication that a client device visited a redirection page at a time to, where the redirection page further collects a user identifier and a geographic location from the client device. The redirection page may use various mechanisms to collect the user identifier, such as by obtaining the user identifier from information stored in a data-augmented link, from a browser memory, from a native application memory, or from some other portion of device memory. Some embodiments may access a third-party database to obtain evaluation data by sending a request to an API, where the request may indicate a candidate user identifier or the geographic location. In some embodiments, the evaluation data indicates that the evaluation data was provided by a user identified by the candidate user identifier. Some embodiments may then determine that the candidate user identifier matches a user identifier and that the evaluation data was generated at an evaluation timestamp t₁. Some embodiments may then determine that the set of verification criteria is satisfied based on a determination that the evaluation timestamp is within the time threshold duration between t to (t₀+DT), where DT is a pre-configured duration.

Some embodiments may implement a heuristic approach based on detected matches between evaluation data provided by a first user and at least one of device-provided data, data provided by another user, or data provided via a data-augmented link. For example, some embodiments may obtain a set of names, user-indicated locations, phone numbers, or other identifying information associated with a first user by accessing a record associated with the first user or obtained from other users or a data-augmented link. Some embodiments may then detect matches between such information and evaluation data obtained from a third-party data source. Some embodiments may then count or weigh each detected match to determine a verification score based on detected matches between the identifying information and the evaluation data.

In some embodiments, a match may be determined as a shared identifier. For example, some embodiments may detect a match between client-associated information and evaluation data based on a shared IP address. Furthermore, some embodiments may modify a verification score based on the satisfaction of other verification criteria. For example, some embodiments may determine that a set of evaluation data was provided by a user within a threshold duration of a time value representing the time at which the user accessed the first destination or was redirected from the first destination. In response, some embodiments may increase a verification score that is compared against a verification score threshold to determine whether the set of verification criteria is satisfied.

In response to a determination that the set of verification criteria is satisfied, operations of the process 200 may proceed to operations described for block 220. Otherwise, operations of the process 200 may proceed to operations described for block 218.

Some embodiments may indicate evaluation data for further analysis, as indicated by block 218. For example, some embodiments may determine that evaluation data matches a geographic location, a user identifier, or other data associated with a user or task but that a corresponding set of verification criteria is not satisfied. Some embodiments may store the collected evaluation data in a record separate from map-related records described for block 230 below and flag the separated record for further review.

Some embodiments may select a geographic region from a set of geographic regions based on a location associated with the evaluation data, as indicated by block 220. As described elsewhere, a location may be associated with evaluation data through various mechanisms. In some embodiments, a first location may be associated with a task record after a first user sends a request indicating a task identifier for the task record and a first location to an application executing on a server. Alternatively, some embodiments may obtain a first location value from a redirection page, where the value of the first location may be obtained directly from a client device (e.g., a redirection page may request a location from a client device and receive permission to obtain the client device location) or may be provided from a data sent via a data-augmented link. In response to determining that a set of verification criteria is satisfied based on a set of evaluation data, some embodiments may then associate the first location with the evaluation data. Some embodiments may then select a geographic region associated with the first location, where the first location is within the selected geographic region.

In some embodiments, a geographic region may be split into a government-established region (e.g., zip codes, counties, municipality-defined segments). Alternatively, a set of geographic regions may be defined by third-party-obtained maps of geographic regions, user-defined geographic regions, or divisions based on latitude and longitude lines. In some embodiments, geographic regions may divide an area into street-defined blocks or aggregations of street-defined blocks, such as a city block or a set of city blocks representing a neighborhood of a city. Furthermore, some embodiments may divide an area into geographic regions based on defined natural or man-made boundaries, such as bodies of water, hills, buildings, etc.

Some embodiments may update a record based on the geographic region based on the evaluation data, as indicated by block 230. Some embodiments may update a record associated with a geographic region by updating an existing record of a data store or generating a new record for the data store. In some embodiments, the record associated with the geographic region may be a record representing evaluation data. For example, a first set of records may be indexed by geographic region and may include evaluation data, such that each respective record of the first set of records includes respective evaluation data corresponding with an evaluation of one task performed by an organization. Alternatively, or additionally, the record associated with the geographic region may be a record representing a geographic region. Alternatively, or additionally, the record associated with the geographic region may be a record representing a task-performing entity that may perform one or more tasks within one or more geographic regions. Furthermore, in some embodiments, a record of a set of records being updated may also include values indicating a task identifier, organization identifier, task-performing user identifier, and an evaluation address link indicating a source for the evaluation data. Some embodiments may then update these geographic-region-associated records.

In response to a determination that a set of evaluation data satisfies a set of verification criteria, some embodiments may generate a record in a data store that associates the evaluation data with a previously determined location or a second set of user data, where the second set of user data may be associated with a service-providing user or organization. For example, some embodiments may first determine that a location “LOCATION1” is associated with a set of evaluation data based on a result indicating that a set of verification criteria is satisfied by the set of evaluation data. If the location “LOCATION1” is within a geographic region “REGION1,” some embodiments may associate the region “REGION1” with the set of evaluation data. Some embodiments may perform such an association by updating a record for the region “REGION1” to include one or more values of the set of evaluation data. Alternatively, or additionally, some embodiments may generate a new record that includes a category value for the region “REGION1” and some or all values of the set of evaluation data. For example, some embodiments may update a database of records to include a new record that indicates “REGION1,” “LOCATION1,” text input obtained from the set of evaluation data, a first set of image data obtained from the set of evaluation data, a task identifier, and a second set of image data obtained from a task-performing user.

In some embodiments, a map-related data store may include a first set of records representing geographic regions and a second set of records, where each respective record of the second record may represent a respective task-performing entity and includes a record property indicating one or more geographic regions with which the task-performing entity is associated. In some embodiments, the records of the second set of records may include evaluation data for the task-performing entities, where the evaluation data may include the text sequence related to the task-performing entity and an evaluation address link to other parts of the evaluation data. Alternatively, or additionally, some embodiments may update records associated with the geographic region directly, such that a record corresponding with a geographic area may include values corresponding with evaluation data. Alternatively, or additionally, a map-related data store may include a third set of records such that each respective record of the third set of records represents a specific set of evaluation data corresponding with a specific post.

In some embodiments, a data store of records being updated may be uniquely generated or updated for a specific entity (e.g., a specific user). In some embodiments, at least one record of the data store may be associated with a specific service provided by the organization. Alternatively, or additionally, a global data store indicating multiple organizations may be updated using operations described in this disclosure.

Some embodiments may display a map that includes updated record information, as indicated by block 234. Some embodiments may display a geographic map that includes evaluation information. For example, some embodiments may send a map-related message to a client device, where the map-related message includes indicators of one or more geographic regions to be displayed, one or more sets of evaluation data to be displayed concurrently with the geographic regions, or associations between the set of evaluation data and the geographic regions. In some embodiments, the message may cause the client device to present a visual representation of the set of geographic regions, a set of evaluation text sequences overlaid on top of the set of geographic regions, and a set of evaluation address links to indicate data sources for the set of evaluation text sequences.

Some embodiments may filter information displayed on the geographic map based on a set of queries provided by a user. For example, a query may indicate a geographic location and a minimum verification score. Some embodiments may then display icons representing evaluation data at assigned locations of geographic regions at a geographic location representing the center of the geographic regions.

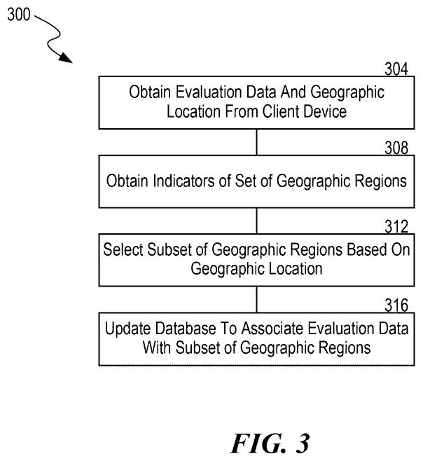

FIG. 3 shows a flowchart of a process 300 for associating evaluation data with geographic regions, in accordance with one or more embodiments. Some embodiments may obtain evaluation data and a geographic location from the client device, as indicated by block 304. Obtaining evaluation data and geographic location may include obtaining evaluation data from a native application that is executing on a client device, where the geographic information may be provided concurrently with the evaluation data or independently of the evaluation data. For example, a user may use a computing device to provide evaluation data that includes a text sequence (e.g., “REVIEW TEXT 1 RATING JUSTIFICATION 1”) and a numeric score using a native application executing on the computing device. After the user submits the evaluation data, some embodiments may obtain a location of the mobile computing device in association with the evaluation data. For example, the native application may automatically communicate a device location of the computing device to a server application, where the server application may then associate the device location with the evaluation data in a record.

Some embodiments may obtain indicators of a set of geographic regions, as indicated by block 308. In some embodiments, a map-related data store may include or otherwise indicate a set of geographic regions, where a geographic location may be within one region of the set of geographic regions if the geographic regions do not overlap. It should be understood that a location may be within multiple geographic regions if the geographic regions are permitted to overlap. In some embodiments, a geographic region may be dynamically defined, where different operations may be performed to determine the boundaries of the geographic region. A geographic region may be defined by streets, undeveloped areas, or bodies of water. In some embodiments, a geographic region may be defined as consisting of multiple smaller geographic regions. For example, a geographic region may include multiple blocks, where the multiple blocks may be associated with each other based on a shared identifier or category. Some embodiments may obtain a sector map from a third-party data source, such as a third-party data source or other data source that groups regions based on city blocks, neighborhoods, ZIP codes, municipal borders, and physical borders.

Some embodiments may select a subset of geographic regions based on the geographic location, as indicated by block 312. Some embodiments may select a geographic region because the geographic region includes the geographic location. Alternatively, or additionally, some embodiments may select a geographic region based on an association between the geographic region and another geographic region that includes the geographic location.

Some embodiments may update a data store to associate the evaluation data with the subset of geographic regions, as indicated by block 316. A data store may include a first set of records representing task-performing entities. Each respective record of the first set of records may be associated with a respective set of task records, where each respective task record of the respective entity record represents a task that was performed by an entity identified by the respective entity record. Some embodiments may update a record of the first set of records by selecting the record based on a task identifier associated with the evaluation data (e.g., provided directly by the evaluation data, associated with the evaluation data via a data-augmented link, etc.) and updating the task record to include the evaluation data or associate the task record with another record storing the evaluation data. Furthermore, some embodiments may update an index of evaluation data, where the index includes identifiers of geographic regions. In some embodiments, indexing evaluation data by the geographic regions may increase the speed of retrieving evaluation data based on the geographic regions.

Some embodiments may update evaluation data to anonymize user information or generate a modified version of evaluation data. For example, some embodiments may modify a user-provided or device-provided location before storing the location information. The modified location may be converted to a different location. For example, some embodiments may detect that a user has entered an address or other location information in a text input by using a regular expression pattern. Some embodiments may then select a geographic region containing the address and replace the address with a name of the geographic region or other indicator of the geographic region. Some embodiments may then update a record associated with the geographic region in a map-related database or other type of map-related data store to include the modified version of the user-provided evaluation data.

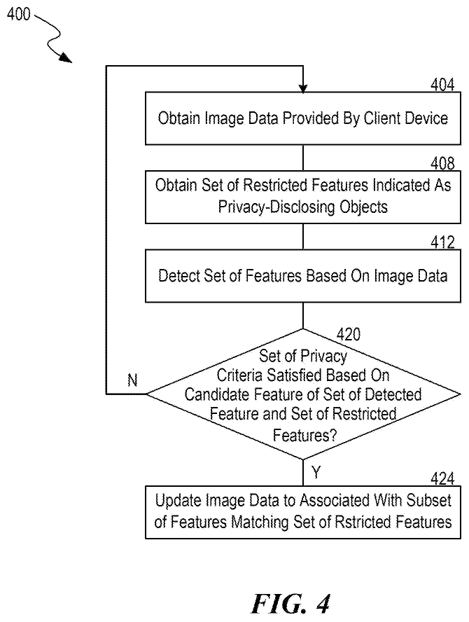

FIG. 4 shows a flowchart of a process 400 for anonymizing visual information to maintain user privacy, in accordance with one or more embodiments. Some embodiments may obtain image data provided by a client device, as indicated by block 404. Some embodiments may obtain image data with a camera of the client device via a connection between the client device and an image-capturing device or via some other means. The image data may include still images, such as a picture. Alternatively, or additionally, the image data may include video data that is encoded in one of various encoding schemes.

Some embodiments may obtain a set of restricted features indicated as privacy-disclosing objects, as indicated by block 408. Some embodiments may obtain a set of restricted features from a database server or another data source. In some embodiments, the set of restricted features may be provided by default. For example, in some embodiments, “human face” may be a restricted feature by default. Alternatively, or additionally, some embodiments may obtain or update a set of restricted features based on user-entered information, a task identifier, a user identifier, a task-performing entity identifier, etc. For example, some embodiments may receive image data from a user having a user profile record. Some embodiments may then obtain a set of restricted features defined by the user profile record or another record associated with a user identifier of the user.

Some embodiments may associate image data obtained from a device with a label indicating that the image data is associated with a public location or a private location based on at least one of a device location of the device or the content of the image data. For example, some embodiments may determine that a device location is in a residential area and, in response, associate the image data taken by the device with a label indicating a private location. Alternatively, or additionally, some embodiments may classify image data including an image of a public location and, in response, associate the image data with a label indicating a public location. For example, some embodiments may provide image data to a machine learning classifier trained to classify an image as private or public.

Some embodiments may select a first set of restricted features in lieu of another set of restricted features or update a set of restricted features based on the label indicating a public or private location. For example, some embodiments may select a first set of restricted features that includes the feature “floor” in lieu of a second set of restricted features that does not include the feature “floor” if an image or device used to obtain the image is labeled as “private” and select the second set of features if the image or device used to obtain the image is labeled “public.” Alternatively, or additionally, some embodiments may select a first set of restricted features in lieu of a second set of restricted features or update the set of restricted features based on information provided via a user interface. For example, a user may select the option “private residence” to indicate that image data and other data provided from a client device is private. Some embodiments may then update a set of restricted features assigned to the image to include the feature “floor.” Some embodiments may then detect the presence of a first image portion labeled as “floor” and perform a response action as described elsewhere in this disclosure (e.g., blur, cover in a color, or otherwise obfuscate the first image portion).

Some embodiments may detect a set of features based on the image data, as indicated by block 412. Some embodiments may detect a set of features by providing image data to an object recognition model. For example, some embodiments may provide still images provided in conjunction with evaluation data to a trained convolutional neural network being used as a part of an object recognition model to detect the presence of features such as “floor,” “roof,” “cabinet,” or “wiring.”

Some embodiments may use a submodule of a client device to use an object recognition module to perform one or more recognition operations. For example, in some embodiments, an application executing on a client device may use a CPU, GPU, or TPU of a client device when providing image data to an object recognition model to detect one or more objects of an image. The one or more recognized objects may be associated with portions of the image and communicated to a server to perform other operations described in this disclosure. Alternatively, as described elsewhere in this disclosure, the client device may obfuscate a recognized object based on a determination that the recognized object matches a restricted object in a set of restricted objects and modify a portion of the image associated with the recognized object before providing the image to a database or another data store.

Some embodiments may determine whether a set of privacy criteria is satisfied based on a candidate feature of the set of detected features and the set of restricted features, as indicated by block 420. Some embodiments may iteratively select some or all detected features as a candidate feature and determine whether the candidate feature matches a feature of the set of restricted features. For example, some embodiments may determine that a candidate feature of an image is labeled “human face” and thus matches with the feature “human face” found in the set of restricted features. As described elsewhere, the set of restricted features may include various types of objects, such as a human face, a portion of a human arm, another portion of the human body, an animal, a character sequence (e.g., a text sequence in an image, a license plate, a home address), etc.

Some embodiments may use a heuristic to determine a privacy risk score. For example, some embodiments may determine whether a detected object is identified in a list of identifiers of privacy-disclosing objects and assign a privacy risk score based on a match with one or more of privacy-disclosing objects. Some embodiments may then compare the privacy risk score to a privacy risk threshold to determine whether a set of privacy criteria is satisfied. For example, some embodiments may use a neural network or other machine learning model to assign a privacy risk score based on a set of detected features after training the neural network with a training set.

In response to a determination that the set of privacy criteria is satisfied, operations of the process 400 may proceed to operations described for block 424. Otherwise, operations of the process 400 may return to operations described for block 404 after a new image is obtained.

Some embodiments update image data based on a subset of the set of features matching the set of restricted features, as indicated by block 424. Some embodiments may perform a set of responsive actions, where such responsive actions may include anonymizing user-provided personal information or indicating that user-provided data includes personal information.

In some embodiments, the set of responsive actions may include generating a warning indicating a privacy-disclosing object has been detected. Some embodiments may perform operations described in this disclosure in real time, where a warning may be displayed within 5 seconds of taking an image. For example, after a user uses a mobile computing device to obtain an image, some embodiments may detect a portion of a human face in the obtained image. In response, some embodiments may display a warning on a GUI of the mobile computing device, where the warning may recommend that the user take another image.

In some embodiments, the responsive action may include updating the image data to modify or remove the privacy-disclosing object. Some embodiments may blur a portion of an image, where the portion includes an identified object. For example, some embodiments may detect that a set of shapes in a first portion of an image is a sequence of numbers. In response, some embodiments may blur or otherwise obfuscate the image. Alternatively, or additionally, some embodiments may remove the portion of the image, where removing an image may include changing the color or brightness values of the image such that the portion of the image is no longer visible or cropping the image such that the portion of the image is cropped out. Furthermore, some embodiments may block the use of content entirely due to the type of privacy-disclosing content that exists on it.

Some embodiments may determine which responsive action or set of responsive actions to take based on a determined privacy risk score. Furthermore, some embodiments may switch between providing an option to obfuscate or block content with a warning or automatically obfuscating or blocking content based on the privacy risk score. For example, if a privacy risk score is above a first threshold but below a second threshold, some embodiments may cause a UI to display a warning message. If the privacy risk score is above the second threshold, some embodiments may obfuscate a portion of an image corresponding with a feature that is elevating the privacy risk score (e.g., a human face).

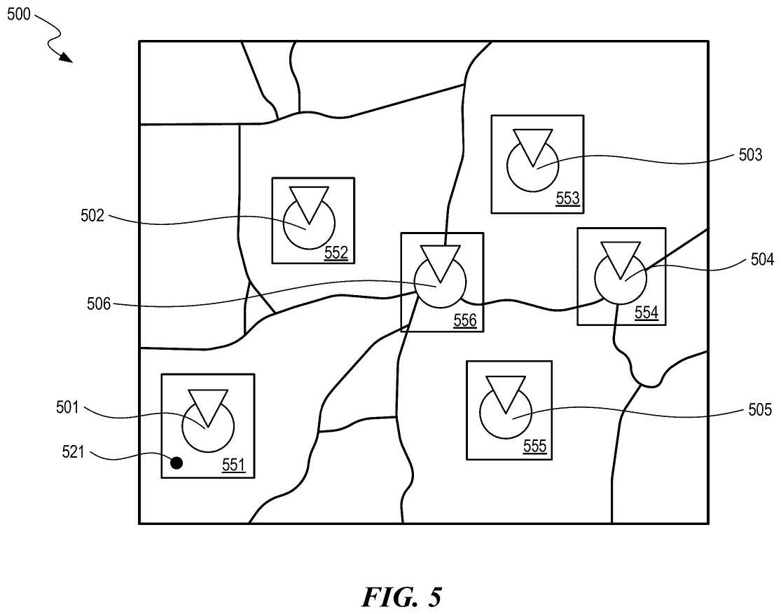

FIG. 5 is an example graphic user interface (GUI) screen 500 that includes a geographic map and geographic locations representing geographic regions, in accordance with one or more embodiments. The GUI screen 500 includes a set of geographic locations 501-506. In some embodiments, each respective location of the set of geographic locations 501-506 may represent a default location for a respective geographic region of the set of geographic regions 551-556.

In some embodiments, user location information may be anonymized to protect user privacy. For example, some embodiments may obtain evaluation data that is associated with a geographic location 521. Some embodiments may perform operations described in this disclosure to select a first geographic region 551, which may be represented by the first geographic location 501. Some embodiments may display the obtained evaluation data (e.g., text, images, video data, etc.) in association with the geographic location 501. Some embodiments may then determine a number of other mobile computing devices within a predetermined geographic range of the actual geographic location 521 or the first geographic location 501 and send a link or identifier of evaluation data to these other mobile computing devices.

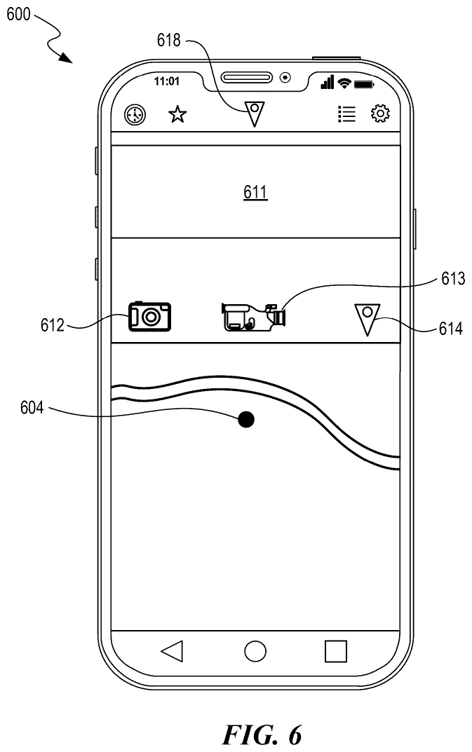

FIG. 6 is an example GUI screen 600 used by a first user to provide geographic location information for a service, in accordance with one or more embodiments. In some embodiments, a user that is executing a native application on a mobile computing device may interact with the GUI screen 600, where the mobile computing device is determined to be at the geographic location 604. The user may then enter information into a text box 611, obtain a picture by interacting with a UI element 612, obtain video recording by interacting with a UI element 613, or obtain the geographic location 604 by interacting with a UI element 614. Some embodiments may initiate a posting operation to upload such information in response to a user interaction with a UI element 618. In some embodiments, the posting operation may update a task-related record, a user record, or another record described in this disclosure that the record will include or will be otherwise associated with the geographic location 604.

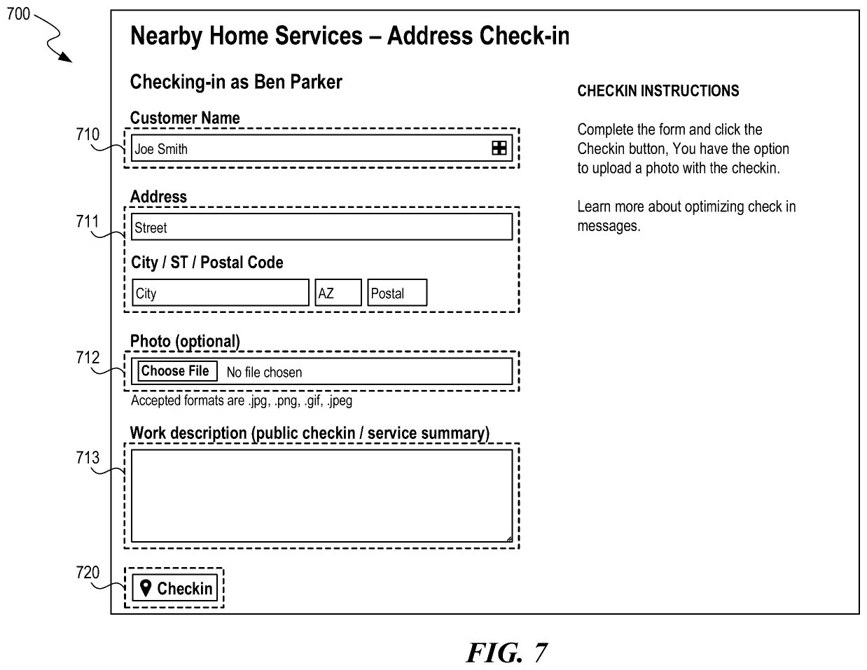

FIG. 7 is an example GUI screen 700 used by a first user to provide task-related information, in accordance with one or more embodiments. In some embodiments, a GUI screen 700 may be displayed on a first computing device. A first user may interact with the GUI screen 700 to enter task-related information. For example, the first user may be a task-performing entity that may enter a second user's information via a UI element 710 representing a name box and a set of UI elements 711 representing a set of address fields. The first user may also provide one or more images via a UI element 712 and provide a text sequence characterizing a task being performed in a UI element 713. Once the first user taps on the submission button 720, the first computing device may send a message that includes data provided in the UI elements 710-713 to a server.

After receiving the message, some embodiments may generate or otherwise update a task-related record indicating the task characterized by the data entered into the UI elements 710-713. For example, some embodiments may use the information provided by the set of UI elements 711 as a location or may convert this information into a location (e.g., by conforming the address into a system-recognized coordinate). Some embodiments may then update the task-related record to comprise the location data.

In some embodiments, the interaction with the submission button 720 may cause the first computing device to send, to a server, a request to send a link to a second computing device. Some embodiments may look up a user record based on information provided in the UI element 710 to retrieve a phone number associated with the user identified by the UI element 710. Some embodiments may then send a link to the phone number, where the link may include an encoded or unencoded form of values entered into one or more UI elements of the UI elements 710-713 or data derived from data entered into the one or more UI elements of the UI elements 710-713. As described elsewhere in this disclosure, some embodiments may use one or more operations described in this disclosure to associate evaluation data with a task record generated or otherwise updated with data entered into the GUI screen 700.

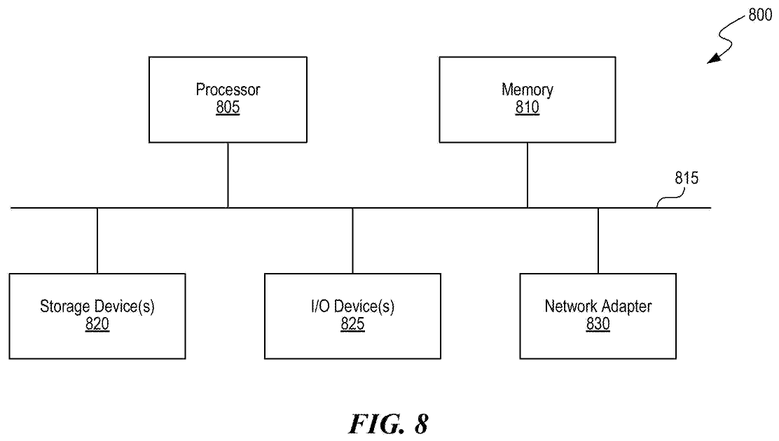

FIG. 8 is a block diagram of a computer system 800 that may be used to implement certain features of some of the embodiments. The computer system 800 may include a set of central processing units (“set of processors”) 805, memory 810, input/output devices 825, e.g., keyboard and pointing devices, touch devices, display devices, storage devices 820, e.g., disk drives, and network adapters 830, e.g., network interfaces, that are connected to an interconnect 815. The interconnect 815 is illustrated as an abstraction that represents any one or more separate physical buses, point-to-point connections, or both connected by appropriate bridges, adapters, or controllers. The interconnect 815, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), an IIC (12C) bus, or an Institute of Electrical and Electronics Engineers (IEEE) standard 1394 bus, also called FireWire.

The memory 810 and storage devices 820 are computer-readable storage media that may store program instructions that implement at least portions of the various embodiments. In addition, the data structures and message structures may be stored or transmitted via a data transmission medium, e.g., a signal on a communications link. Various communications links may be used, e.g., the Internet, a local area network, a wide area network, or a point-to-point dial-up connection. Thus, computer readable media can include computer-readable storage media, e.g., non-transitory media, and computer-readable transmission media.

The program instructions stored in memory 810 can be implemented as software and/or firmware to program the set of processors 805 to carry out one or more operations described in this disclosure. In some embodiments, such software or firmware may be initially provided to the computer system 800 by downloading it from a remote system through the computer system 800, e.g., via network adapter 830.

It should be noted that the features and limitations described in any one embodiment may be applied to any other embodiment herein, and a flowchart or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The various embodiments introduced herein can be implemented by, for example, programmable circuitry, e.g., one or more microprocessors, programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

With respect to the components of computer devices described in this disclosure, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Further, some or all of the computer devices described in this disclosure may include a user input interface and/or user output interface (e.g., a display) for use in receiving and displaying data. In some embodiments, a display such as a touchscreen may also act as a user input interface. It should be noted that in some embodiments, one or more devices described in this disclosure may have neither user input interfaces nor displays and may instead receive and display content using another device (e.g., a dedicated display device such as a computer screen and/or a dedicated input device such as a remote control, mouse, voice input, etc.). Additionally, one or more of the devices described in this disclosure may run an application (or another suitable program) that performs one or more operations described in this disclosure.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment may be combined with one or more features of any other embodiment.

As used throughout this application, the word “may” is used in a permissive sense (i.e., meaning having the potential to), rather than the mandatory sense (i.e., meaning must). The words “include,” “including,” “includes,” and the like mean including, but not limited to. As used throughout this application, the singular forms “a,” “an,” and “the” include plural referents unless the context clearly indicates otherwise. Thus, for example, reference to “an element” or “an element” includes a combination of two or more elements, notwithstanding use of other terms and phrases for one or more elements, such as “one or more.”

The term “or” is non-exclusive (i.e., encompassing both “and” and “or”), unless the context clearly indicates otherwise. Terms describing conditional relationships (e.g., “in response to X, Y,” “upon X, Y,” “if X, Y,” “when X, Y,” and the like) encompass causal relationships in which the antecedent is a necessary causal condition, the antecedent is a sufficient causal condition, or the antecedent is a contributory causal condition of the consequent (e.g., “state X occurs upon condition Y obtaining” is generic to “X occurs solely upon Y” and “X occurs upon Y and Z”). Such conditional relationships are not limited to consequences that instantly follow the antecedent obtaining, as some consequences may be delayed, and in conditional statements, antecedents are connected to their consequents (e.g., the antecedent is relevant to the likelihood of the consequent occurring).

Statements in which a plurality of attributes or functions are mapped to a plurality of objects (e.g., one or more processors performing steps/operations A, B, C, and D) encompass both all such attributes or functions being mapped to all such objects and subsets of the attributes or functions being mapped to subsets of the objects (e.g., both all processors each performing steps/operations A-D, and a case in which processor 1 performs step/operation A, processor 2 performs step/operation B and part of step/operation C, and processor 3 performs part of step/operation C and step/operation D), unless otherwise indicated. Further, unless otherwise indicated, statements that one value or action is “based on” another condition or value encompass both instances in which the condition or value is the sole factor and instances in which the condition or value is one factor among a plurality of factors.

Unless the context clearly indicates otherwise, statements that “each” instance of some collection have some property should not be read to exclude cases where some otherwise identical or similar members of a larger collection do not have the property (i.e., each does not necessarily mean each and every). Limitations as to sequence of recited steps should not be read into the claims unless explicitly specified (e.g., with explicit language like “after performing X, performing Y”), in contrast to statements that might be improperly argued to imply sequence limitations (e.g., “performing X on items, performing Y on the X′ed items”) used for purposes of making claims more readable rather than specifying sequence. Statements referring to “at least Z of A, B, and C” and the like (e.g., “at least Z of A, B, or C”) refer to at least Z of the listed categories (A, B, and C) and do not require at least Z units in each category.

Unless the context clearly indicates otherwise, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. Furthermore, unless indicated otherwise, updating an item may include generating the item or modifying an existing item. Thus, updating a record may include generating a record or modifying the value of an already-generated value.

Unless the context clearly indicates otherwise, ordinal numbers used to denote an item do not define the item's position. For example, an item that may be a first item of a set of items even if the item is not the first item to have been added to the set of items or is otherwise indicated to be listed as the first item of an ordering of the set of items. Thus, for example, if a set of items is sorted in a sequence from “item 1,” “item 2,” and “item 3,” a first item of a set of items may be “item 2” unless otherwise stated. Furthermore, it should be under stood that a set of items may refer to only a singular item or may refer to multiple items.

The present techniques will be better understood with reference to the following enumerated embodiments:

1. A method comprising: providing, to a client device, a link to an intermediate destination; obtaining a redirection time from the client device via the intermediate destination; obtaining a location and a user identifier; retrieving evaluation data comprising a text sequence, an evaluation time, and a candidate user identifier; determining a result indicating that the evaluation data satisfies a set of verification criteria; and in response to determining the result, updating a record associated with a geographic region in a map-related data store by: selecting the record associated with the geographic region based on the location; and updating the record associated with the geographic region to comprise the text sequence.

2. The method of embodiment 1, wherein satisfying the set of verification criteria comprises determining that the evaluation time is within a threshold duration of the redirection time and determining a match between the candidate user identifier and the user identifier.

3. A method comprising: sending, to a client device, a link to an intermediate destination that redirects a user to evaluation entry interface; obtaining a redirection timestamp from the client device via the intermediate destination; obtaining a location associated with the client device and a user identifier associated with the client device; obtaining evaluation data from a data store, wherein the evaluation data comprises a text sequence representing user-provided text input, an evaluation timestamp, and a candidate user identifier; determining a result indicating that the evaluation data satisfies a set of verification criteria, wherein satisfying the set of verification criteria comprises determining that the evaluation timestamp is within a threshold duration of the redirection timestamp and detecting a match between the candidate user identifier and the user identifier; and in response to determining the result, updating a record associated with a geographic region in a map-related data store by (i) selecting the record associated with the geographic region based on the location and (ii) updating the record associated with the geographic region to comprise the text sequence.

4. A method, the method comprising: sending, to a client device, a link to an intermediate destination that redirects a user to evaluation entry interface; obtaining a redirection time from the client device via the intermediate destination; obtaining a location associated with the client device and a user identifier associated with the client device; obtaining evaluation data comprising a text sequence, an evaluation time, and a candidate user identifier; determining a result indicating that the evaluation data satisfies a set of verification criteria, wherein satisfying the set of verification criteria comprises determining that the evaluation time is within a threshold duration of the redirection time and detecting a match between the candidate user identifier and the user identifier; and in response to determining the result, updating a record associated with a geographic region in a map-related data store by (i) selecting the record associated with the geographic region based on the location and (ii) updating the record associated with the geographic region to comprise the text sequence.

5. The method of any of embodiments 1 to 4, wherein the client device is a first client device, and wherein the evaluation data further comprises an evaluation address link, and wherein updating the record comprises storing the evaluation address link in the record, further comprising: obtaining a request from a second client device; and sending, in response to obtaining the request, a message to the second client device, wherein the message causes the second client device to concurrently display a visual representation of the geographic region and the evaluation address link.

6. The method of any of embodiments 1 to 5, wherein the result is a first result, and wherein the evaluation data further comprises an image address, further comprising: obtaining a request to send the link to the client device, wherein the request is associated with a task identifier, and wherein sending the link comprises sending the link in response to obtaining the request; obtaining a first image from the image address; providing the first image to an object recognition model to detect a first set of features associated with the first image; retrieving a set of criteria based on the task identifier; and determining a second result indicating that the set of criteria is satisfied based on the first set of features, wherein updating the record comprises updating the record based on the second result.

7. The method of any of embodiments 1 to 6, wherein the result is a first result, further comprising: obtaining an image; generating a set of features associated with the image by providing an object recognition model with the image; determining a privacy risk score based on the set of features; determining a second result indicating that the privacy risk score satisfies a threshold; and in response to detecting the second result, blurring or removing a portion of the image corresponding with the set of features.

8. The method of any of embodiments 1 to 7, wherein the evaluation data further comprises an image address, and wherein the result is a first result, further comprising: obtaining a device location of the client device; determining a second result indicating that the device location is a private location; selecting a first set of restricted features in lieu of a second set of restricted features based on the second result; detecting a candidate feature by providing image data retrieved from the image address to an object recognition model; and obfuscating a portion of the image data based on a match between the candidate feature and at least one feature of the first set of restricted features.

9. The method of any of embodiments 1 to 8, further comprising: obtaining an indication that the evaluation data is associated with a label indicating a private location, wherein the evaluation data comprises an image address; selecting a first set of restricted features in lieu of a second set of restricted features based on the indication; detecting a candidate feature by providing image data retrieved from the image address to an object recognition model; and obfuscating a portion of the image data based on a match between the candidate feature and at least one feature of the first set of restricted features.

10. The method of any of embodiments 1 to 9, wherein obtaining the evaluation data comprises obtaining the evaluation data via an application program interface (API) of a data store.

11. The method of any of embodiments 1 to 10, further comprising sending a native application to the client device, wherein: the result is a first result; sending the link to the client device comprises sending the link to the client device via an application program interface (API) of the native application; and the native application performs operations further comprising: obtaining an image; detecting a set of features associated with the image by providing the image to an object recognition model; determining a second result indicating that the set of features comprises features associated with private information; and displaying, on the client device, an indication that the image comprises private information.

12. The method of embodiment 11, wherein determining the second result comprises determining that a restricted feature is detected, wherein the restricted feature is a portion of a human body.

13. The method of any of embodiments 10 to 12, wherein: determining the second result comprises detecting a sequence of characters indicating private information; the native application further performs operations comprising generating a modified version of the image by obfuscating the sequence of characters; and the method further comprises obtaining the modified version of the image from the client device.

14. The method of any of embodiments 1 to 13, wherein providing the link comprises providing the link via a Short Message Service (SMS) message to the client device.

15. The method of any of embodiments 1 to 14, wherein the evaluation data further comprises an evaluation address link, and wherein updating the record comprises storing the evaluation address link in the record, the operations further comprising sending a message to a second client device, wherein the message causes the second client device to concurrently display a visual representation of the geographic region and the evaluation address link.

16. The method of any of embodiments 1 to 15, the operations further comprising: obtaining a task identifier based on an association between the link and the task identifier; retrieving a set of restricted features based on the task identifier; obtaining an image from the client device; detecting a candidate feature by providing the image to an object recognition model, wherein the candidate feature is associated with a portion of the image; determining a second result indicating that the candidate feature is associated with a feature of the set of restricted features; and obfuscating the portion of the image based on the second result.

17. The method of any of embodiments 1 to 16, wherein the result is a first result, and wherein the evaluation data further comprises an image address, the operations further comprising: obtaining a request to send the link to the client device, wherein the request is associated with a task identifier, and wherein sending the link comprises sending the link with an indication of the task identifier; obtaining a first image from the image address; providing the first image to an object recognition model to detect a first set of features associated with the first image; retrieving a set of criteria based on obtaining the task identifier via the intermediate destination; determining a second result indicating that the set of criteria is satisfied based on the first set of features, wherein updating the record comprises updating the record based on the second result.

18. The method of any of embodiments 1 to 17, wherein the result is a first result, the operations further comprising: obtaining an image; generating a set of features associated with the image by providing an object recognition model with the image; determining a privacy risk score based on the set of features; determining a second result indicating that the privacy risk score satisfies a threshold; and in response to detecting the second result, blurring or removing a portion of the image corresponding with the set of features.

19. The method of any of embodiments 1 to 18, wherein the result is a first result, and wherein the evaluation data further comprises an image address, the operations further comprising: obtaining a device location of the client device; determining a second result indicating that the device location is a private location; selecting a first set of restricted features in lieu of a second set of restricted features based on the second result; detecting a candidate feature by providing image data retrieved from the image address to an object recognition model; and obfuscating a portion of the image data based on a match between the candidate feature and at least one feature of the first set of restricted features.

20. The method of any of embodiments 1 to 19, the operations further comprising: obtaining a first message indicating a task identifier and the location; and generating the record based on the task identifier and the location, wherein generating the record comprises: determining that the location is in a geographic location; and associating the record with the geographic location based on the determination that the location is in the geographic location.

21. The method of any of embodiments 1 to 20, wherein the record is a first record, the operations further comprising: obtaining a first message indicating a task identifier and the location; generating a task record based on the task identifier, wherein the task record indicates the location; and associating the task record with the first record based on the result.

22. The method of any of embodiments 1 to 21, wherein the link comprises a data store information identifier; and obtaining the location and the user identifier comprises: generating a query based on the data store information identifier; and sending the query to a second data store to retrieve the location and the user identifier.

23. One or more tangible, non-transitory, machine-readable media storing instructions that, when executed by a set of processors, cause the set of processors to effectuate operations comprising those of any of embodiments 1 to 22.

24. A system comprising: a set of processors and a set of media storing computer program instructions that, when executed by the set of processors, cause the set of processors to effectuate operations comprising those of any of embodiments 1 to 22.

What is claimed is:

1. A system for associating text inputs with region records based on timestamps collected during a redirection operation, the system comprising one or more non-transitory, machine-readable media storing program instructions that, when executed by one or more processors, cause the one or more processors to perform operations comprising:
sending, to a client device, a link to an intermediate destination that redirects a user to evaluation entry interface;
obtaining a redirection timestamp from the client device via the intermediate destination;
obtaining a location associated with the client device and a user identifier associated with the client device;
obtaining evaluation data from a data store, wherein the evaluation data comprises a text sequence representing user-provided text input, an evaluation timestamp, and a candidate user identifier;
determining a result indicating that the evaluation data satisfies a set of verification criteria, wherein satisfying the set of verification criteria comprises determining that the evaluation timestamp is within a threshold duration of the redirection timestamp and detecting a match between the candidate user identifier and the user identifier; and
in response to determining the result, updating a record associated with a geographic region in a map-related data store by (i) selecting the record associated with the geographic region based on the location and (ii) updating the record associated with the geographic region to comprise the text sequence.

2. A method, the method comprising:
sending, to a client device, a link to an intermediate destination that redirects a user to evaluation entry interface;
obtaining a redirection time from the client device via the intermediate destination;
obtaining a location associated with the client device and a user identifier associated with the client device;
obtaining evaluation data comprising a text sequence, an evaluation time, and a candidate user identifier;
determining a result indicating that the evaluation data satisfies a set of verification criteria, wherein satisfying the set of verification criteria comprises determining that the evaluation time is within a threshold duration of the redirection time and detecting a match between the candidate user identifier and the user identifier; and
in response to determining the result, updating a record associated with a geographic region in a map-related data store by (i) selecting the record associated with the geographic region based on the location and (ii) updating the record associated with the geographic region to comprise the text sequence.

3. The method of claim 2, wherein:
the link comprises a data store information identifier; and
obtaining the location and the user identifier comprises:
generating a query based on the data store information identifier; and
sending the query to a second data store to retrieve the location and the user identifier.

4. The method of claim 2, wherein the client device is a first client device, and wherein the evaluation data further comprises an evaluation address link, and wherein updating the record comprises storing the evaluation address link in the record, further comprising:
obtaining a request from a second client device; and
sending, in response to obtaining the request, a message to the second client device, wherein the message causes the second client device to concurrently display a visual representation of the geographic region and the evaluation address link.

5. The method of claim 2, wherein the result is a first result, and wherein the evaluation data further comprises an image address, further comprising:
obtaining a request to send the link to the client device, wherein the request is associated with a task identifier, and wherein sending the link comprises sending the link in response to obtaining the request;
obtaining a first image from the image address;
providing the first image to an object recognition model to detect a first set of features associated with the first image;
retrieving a set of criteria based on the task identifier; and
determining a second result indicating that the set of criteria is satisfied based on the first set of features, wherein updating the record comprises updating the record based on the second result.

6. The method of claim 2, wherein the result is a first result, further comprising:
obtaining an image;
generating a set of features associated with the image by providing an object recognition model with the image;
determining a privacy risk score based on the set of features;
determining a second result indicating that the privacy risk score satisfies a threshold; and
in response to detecting the second result, blurring or removing a portion of the image corresponding with the set of features.

7. The method of claim 2, wherein the evaluation data further comprises an image address, and wherein the result is a first result, further comprising:
obtaining a device location of the client device;
determining a second result indicating that the device location is a private location;
selecting a first set of restricted features in lieu of a second set of restricted features based on the second result;
detecting a candidate feature by providing image data retrieved from the image address to an object recognition model; and
obfuscating a portion of the image data based on a match between the candidate feature and at least one feature of the first set of restricted features.

8. The method of claim 2, further comprising:
obtaining an indication that the evaluation data is associated with a label indicating a private location, wherein the evaluation data comprises an image address;
selecting a first set of restricted features in lieu of a second set of restricted features based on the indication;
detecting a candidate feature by providing image data retrieved from the image address to an object recognition model; and
obfuscating a portion of the image data based on a match between the candidate feature and at least one feature of the first set of restricted features.

9. The method of claim 2, further comprising sending a native application to the client device, wherein:
the result is a first result;
sending the link to the client device comprises sending the link to the client device via an application program interface (API) of the native application; and
the native application performs operations further comprising:
obtaining an image;
detecting a set of features associated with the image by providing the image to an object recognition model;
determining a second result indicating that the set of features comprises features associated with private information; and
displaying, on the client device, an indication that the image comprises private information.

10. The method of claim 9, wherein determining the second result comprises determining that a restricted feature is detected, wherein the restricted feature is a portion of a human body.

11. The method of claim 9, wherein:
determining the second result comprises detecting a sequence of characters indicating private information;
the native application further performs operations comprising generating a modified version of the image by obfuscating the sequence of characters; and
the method further comprises obtaining the modified version of the image from the client device.

12. One or more non-transitory, machine-readable media storing program instructions that, when executed by one or more processors, perform operations comprising:
providing, to a client device, a link to an intermediate destination;
obtaining a redirection time from the client device via the intermediate destination;
obtaining a location and a user identifier;
retrieving evaluation data comprising a text sequence, an evaluation time, and a candidate user identifier;
determining a result indicating that the evaluation data satisfies a set of verification criteria, wherein satisfying the set of verification criteria comprises determining that the evaluation time is within a threshold duration of the redirection time and a match between the candidate user identifier and the user identifier; and
in response to determining the result, updating a record associated with a geographic region in a map-related data store by:
selecting the record associated with the geographic region based on the location; and
updating the record associated with the geographic region to comprise the text sequence.

13. The one or more non-transitory media of claim 12, wherein providing the link comprises providing the link via a Short Message Service (SMS) message to the client device.

14. The one or more non-transitory media of claim 12, wherein the evaluation data further comprises an evaluation address link, and wherein updating the record comprises storing the evaluation address link in the record, the operations further comprising sending a message to a second client device, wherein the message causes the second client device to concurrently display a visual representation of the geographic region and the evaluation address link.

15. The one or more non-transitory media of claim 12, the operations further comprising:
obtaining a task identifier based on an association between the link and the task identifier;
retrieving a set of restricted features based on the task identifier;
obtaining an image from the client device;
detecting a candidate feature by providing the image to an object recognition model, wherein the candidate feature is associated with a portion of the image;
determining a second result indicating that the candidate feature is associated with a feature of the set of restricted features; and
obfuscating the portion of the image based on the second result.

16. The one or more non-transitory media of claim 12, wherein the result is a first result, and wherein the evaluation data further comprises an image address, the operations further comprising:
obtaining a request to send the link to the client device, wherein the request is associated with a task identifier, and wherein sending the link comprises sending the link with an indication of the task identifier;
obtaining a first image from the image address;
providing the first image to an object recognition model to detect a first set of features associated with the first image;
retrieving a set of criteria based on obtaining the task identifier via the intermediate destination; and
determining a second result indicating that the set of criteria is satisfied based on the first set of features, wherein updating the record comprises updating the record based on the second result.

17. The one or more non-transitory media of claim 12, wherein the result is a first result, the operations further comprising:
obtaining an image;
generating a set of features associated with the image by providing an object recognition model with the image;
determining a privacy risk score based on the set of features;
determining a second result indicating that the privacy risk score satisfies a threshold; and
in response to detecting the second result, blurring or removing a portion of the image corresponding with the set of features.

18. The one or more non-transitory media of claim 12, wherein the result is a first result, and wherein the evaluation data further comprises an image address, the operations further comprising:
obtaining a device location of the client device;
determining a second result indicating that the device location is a private location;
selecting a first set of restricted features in lieu of a second set of restricted features based on the second result;
detecting a candidate feature by providing image data retrieved from the image address to an object recognition model; and
obfuscating a portion of the image data based on a match between the candidate feature and at least one feature of the first set of restricted features.

19. The one or more non-transitory media of claim 12, the operations further comprising:
obtaining a first message indicating a task identifier and the location; and
generating the record based on the task identifier and the location, wherein generating the record comprises:
determining that the location is in a geographic location; and
associating the record with the geographic location based on the determination that the location is in the geographic location.

20. The one or more non-transitory media of claim 12, wherein the record is a first record, the operations further comprising:
obtaining a first message indicating a task identifier and the location;
generating a task record based on the task identifier, wherein the task record indicates the location; and
associating the task record with the first record based on the result.
